(19) United States
(12) Patent Application Publication
(10) Pub. No.: US 2008/0179428 A1
(43) Pub. Date: Jul. 31, 2008

(54) Divergent Conduit Nozzle

(76) Inventors: Jean-Pierre Songbe, Saint Pierre En Val (FR); Herve Lompech, Bouttencourt (FR); Herve Imenez, Saint Valery Sur Somme (FR)

Correspondence Address: ST. ONGE STEWARD JOHNSTON & REENS, LLC, 986 BEDFORD STREET, STAMFORD, CT, 06905-5619, US

(21) Appl. No.: 12/016,432

(22) Filed: Jan. 18, 2008

Related U.S. Application Data
(63) Continuation of application No. PCT/FR2006/001555, filed on Jun. 30, 2006.

(30) Foreign Application Priority Data
Jul. 22, 2005 (FR) 05 52285

(51) Int. Cl. B05B 1/34

(52) U.S. Cl. 239/491

(57) ABSTRACT

The invention concerns a spray nozzle comprising a swirling chamber fed with pressurized liquid by a network of channels emerging outside via an ejection conduit. The invention is characterized in that said ejection conduit has an intake section whereof the area and/or the geometry is different from that of the output section.

### CROSS-REFERENCE TO RELATED APPLICATIONS

The present application is a continuation of pending International patent application PCT/FR2006/001555 filed on Jun. 30, 2006 which designates the United States and claims priority from French patent application 0552285 filed on Jul. 22, 2005, the content of which is incorporated herein by reference.

### FIELD OF THE INVENTION

The present invention relates to a spraying nozzle.

More particularly, the invention relates to a spraying nozzle with a diverging duct for a dispenser of liquid cosmetic and pharmaceutical products or perfumes.

### BACKGROUND OF THE INVENTION

Conventional nozzles are mounted on hand-operated dispensers fitted with a pump or a valve and include a swirl chamber positioned downstream of the pump.

Such chamber is fed by means of a network of peripheral channels and opens to the outside through a central ejection duct orientated along the axis of the chamber. Its function is to give a quick rotation movement to the pressurized product flow delivered by the pump or the valve prior to its exhaust to the outside, in the form of an aerosol or a small droplet mist.

The two main parameters for the spraying are the angle of the spraying cone and the dimensions of the product droplets.

In some cases, and depending on the type of the product, it can be necessary to modify the angle of the spraying cone to obtain either a more precise orientation of the product flow. However, it must be possible to perform this adaptation without changing the pump or the valve.

Now, the traditionally used ejection duct has a generally cylindrical contour and the modifications likely to be brought to the dimensions of the duct only (diameter and/or length) do not make it possible to perform such adjustments significantly. Besides, the modifications in the dimensions impart heavy and costly industrial constraints for the manufacturing process (large reconstruction of the injection moulds).

### SUMMARY OF THE INVENTION

The object of the present invention is to solve this technical problem satisfactorily.

This goal is reached, according to the invention with a nozzle characterized in that said ejection duct has a liquid inlet section, the surface area and/or the geometry of which is different from that of the outlet section.

According to an advantageous characteristic, the outlet section of said duct has a surface area which is up to five times as big as that of the inlet section. Such modification in the structure of the duct entails a reduction of the rotation speed of the liquid along the ejection duct and consequently, a reduction in the angle of the spraying cone at the outlet of the hole of said duct.

According to a preferred embodiment, the axis of said duct is parallel to the axis of the swirl chamber and is preferably mixed therewith.

According to a first alternative, the axis of said duct is inclined with respect to the axis of the swirl chamber.

According to another alternative, the inlet section of said duct is shifted with respect to the centre of the swirl chamber.

According to another characteristic, the ratio of the length of the duct to the smallest dimension of its inlet section is between 0.25 and 5.

According to a particular alternative, the outlet section of said duct is elliptic.

According to a specific alternative, the ejection duct is likely to receive an insert, internally fitted and intended to reduce the inner diameter of the product passage.

According to still another alternative, the ejection duct is composed of a tubular element which is added and retained by means of a tight radial tightening in the exhaust hole of the swirl chamber.

The invention makes it possible to adapt the nozzle to various types of products and/or applications while modifying only the geometry of the duct and without it being necessary to change the pump or to modify the structure of the swirl chamber or that of the channels.

Incidentally, the nozzle of the invention can be manufactured in a simplified way since the modifications to be brought to the existing moulds are easy and the new conduct contour makes its removal from the mould easier.

### BRIEF DESCRIPTION OF THE DRAWINGS

Other objects and advantages of the invention will become evident while reading the following description, and referring to the appended drawings, in which:

FIG. 1 shows a perspective view with a partial sectional view of an embodiment of the nozzle of the invention,

FIG. 2 shows an axial sectional view of the embodiment of FIG. 1,

FIG. 3 shows a bottom view, in perspective, of the embodiment of the preceding figures,

FIG. 4 shows an axial sectional view of a first alternative embodiment of the nozzle of the invention,

FIG. 5 shows a bottom view, in perspective, of a second alternative embodiment of the nozzle of the invention.

### DETAILED DESCRIPTION OF THE INVENTION

The nozzle shown in the Figures is intended to be fitted on liquid cosmetic or pharmaceutical products or perfumes spray bottles. Such spray bottles are particularly provided with a pump or a valve for delivering the pressurized liquid from a container such as a bottle (not shown).

The nozzle is positioned close to the end of the spray bottle, downstream of the pump or the valve.

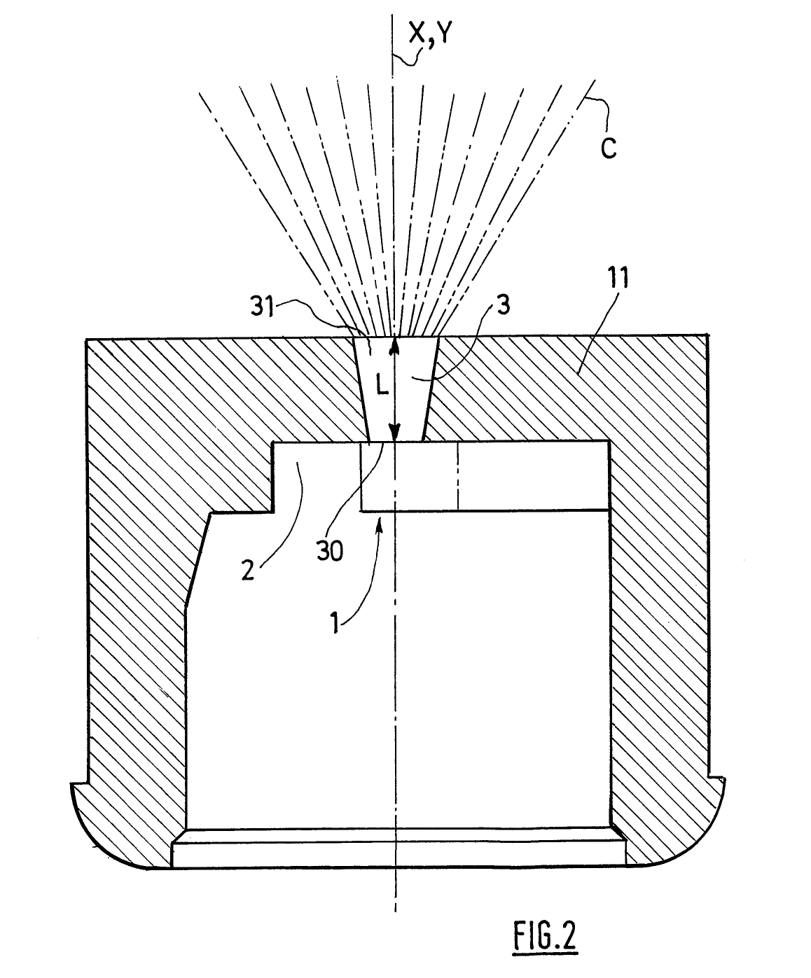

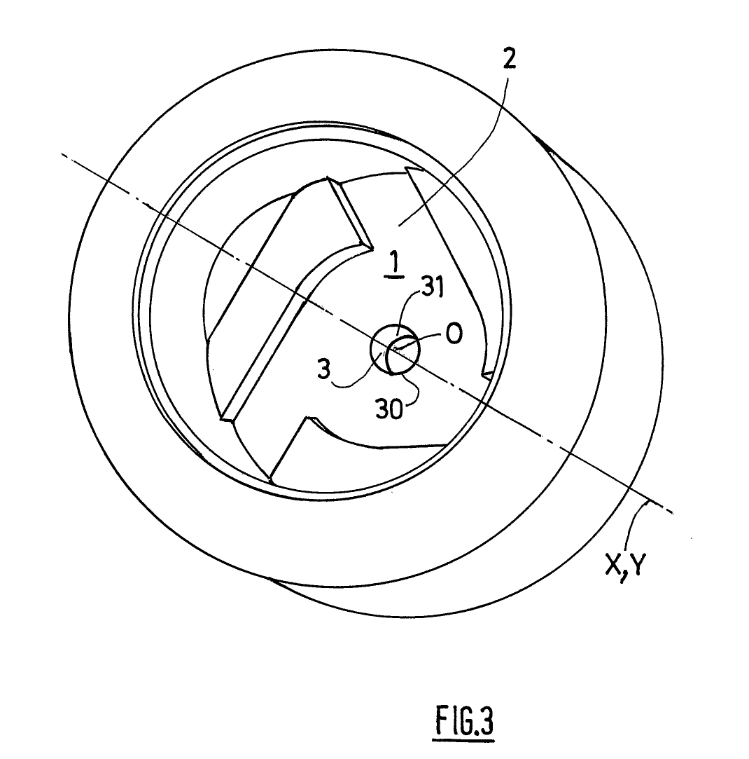

It comprises a swirl chamber 1 set with a pressurized liquid through a network of peripheral channels 2 and opening to the outside via an ejection duct 3 (refer to FIGS. 2 and 3).

It can be produced in situ through the direct molding of the channels on the inner wall or manufactured in the form of an independent part intended to be mounted onto the spray bottle, from the outside.

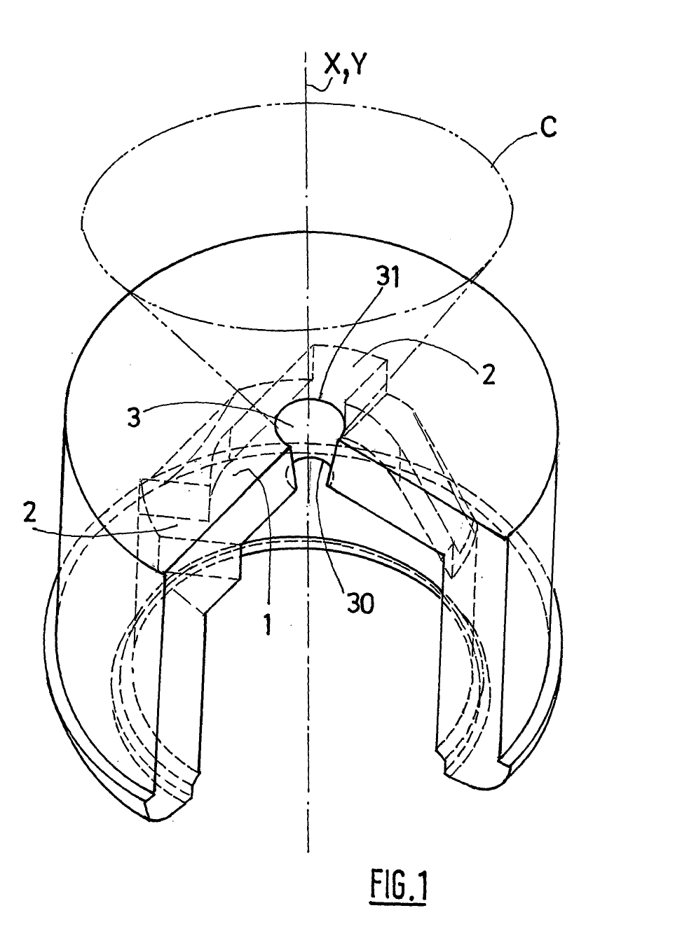

The function of the chamber 1 is to give a quick rotation movement to the liquid prior to its exhaust via the hole defined by the inlet section 30 of the ejection duct 3. The liquid is then dispensed as small droplets to the outside in the form of a conical spraying (indicated by C and materialized with dotted lines in FIGS. 1 and 2), via the outlet section 31 of the duct 3.

The duct 3 is arranged through the end wall of the chamber 1. In FIG. 2, the thickness of the end wall 11 on the chamber 1 corresponds to the length of the duct 3.

According to the invention, the ejection duct 3 has an inlet section 30 for the liquid which is different from the outlet section 31, as regards the surface area and/or the geometry.

In the embodiment of FIG. 1, the ejection duct 3 is tapered with a circular inlet section 30, which is smaller than the circular outlet section 31, so as to form a diverging duct.

The axis Y of the duct is parallel to the axis X of the chamber 1 and is even mixed with it while going through the centre O of the chamber (FIG. 3).

More precisely and as an example, for a duct the length of which is between 0.3 and 0.7 mm, a diameter of the inlet section of 0.32 mm and that of the outlet section 0.48 mm (which corresponds to a ratio of the respective areas of 2.3) the angle on the spraying cone is 55°.

It should be noted that a cylindrical duct having the same length and 0.32 mm in diameter, coupled to a swirl chamber and having identical channels associated with a given pump and/or valve and liquid would produce a cone angle of 90°.

For a ratio of the inlet and outlet sections of 5, the cone angle is 30°.

The spraying angle is thus significantly reduced because of the increase in the difference of the sections of the duct 3 and reversely it increases when such difference in sections diminishes.

Generally speaking, to obtain a significant reduction in the angle of the spraying cone, the outlet section 31 of the duct 3 has a surface area which is up to 5 times as big as that of the inlet section 30.

Besides, the ratio of the length L of the duct 3 to the smallest dimension of its inlet section 30 is between 0.25 and 5. In the case of a circular section, the smallest dimension is the inner diameter of the duct inlet. In case of an elliptic section, the smallest dimension would be the smaller axis.

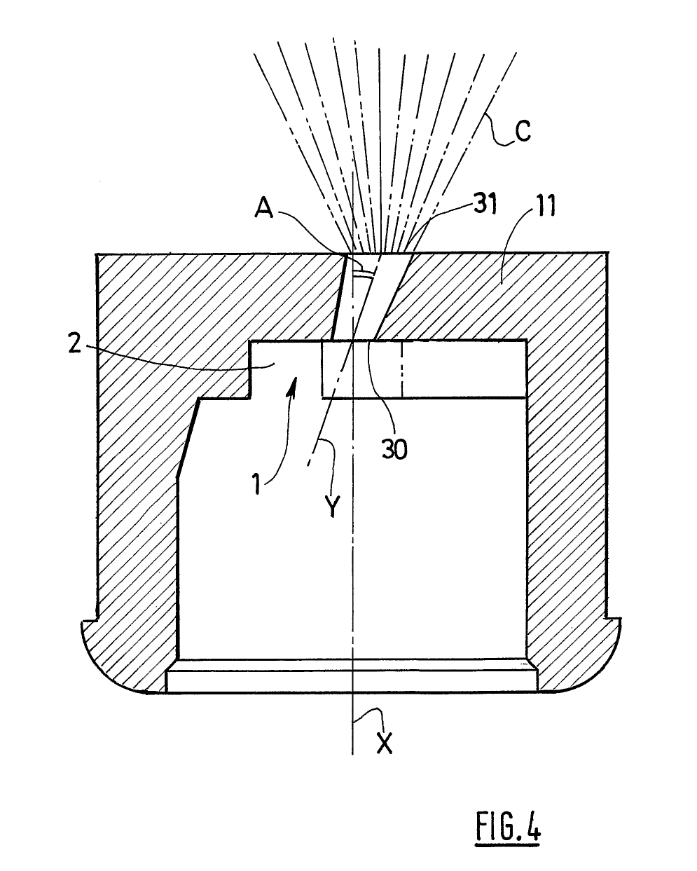

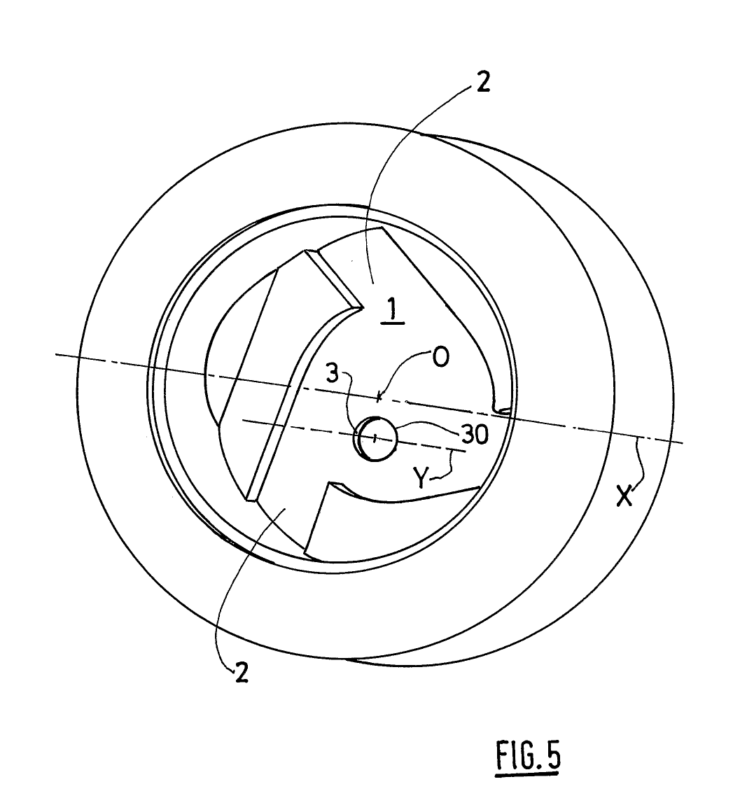

According to an alternative shown in FIG. 4, it is possible to combine such characteristic with an inclination A of the axis Y of the duct 3 with respect to the axis X of the chamber 1 and/or if need be with a shifting of the axis Y of the duct 3 with respect to the center O of the chamber 1 as shown in FIG. 5.

Such provisions make it possible to compensate the pressure and balance in the swirl chamber 1 or to obtain a more of less arched or even a flat spraying shape.

It is also possible to provide an inlet section 30 and an outlet section 31 of the duct 3 with respective contours or shapes having distinct geometries.

For example, the inlet section 30 can be circular whereas the outlet section 31 is elliptic or oval, which generates a spraying having a flat or a bean-like shape.

According to another alternative, not shown, the ejection duct 3 is likely to receive an insert, internally fitted, and intended to reduce the inner diameter of the product passage.

To resist the product pressure during the ejection, it is then preferred to provide a slight radial tightening between the insert and the inner wall of the duct 3.

According to another alternative, the ejection duct is composed of a tubular element, added and retained by means of a tight radial tightening in the exhaust hole of the swirl chamber 1 forming the inlet section 30 of the duct 3.

1. A spraying nozzle comprising a swirl chamber fed with a pressurized liquid through a network of channels and opening onto the outside via an ejection duct the liquid inlet section of which has a surface area and/or a geometry which are different from those of the outlet section, characterized in that the outlet section of said duct has a surface area which is up to 5 times as big as that of its inlet section, so as to reduce the rotation speed of the liquid along said duct and to reduce the angle of the spraying cone at the outlet of said duct.

2. A nozzle according to claim 1, characterized in that the axis of said duct is parallel to the axis of the swirl chamber.

3. A nozzle according to claim 1, characterized in that the axis of said duct is inclined according to an angle with respect to the axis of the swirl chamber.

4. A nozzle according to claim 1, characterized in that the inlet section of said duct is shifted with respect to the centre of the swirl chamber.

5. A nozzle according to claim 1, characterized in what the ratio of the length of the duct to the smallest dimension of its inlet section is between 0.25 and 5.

6. A nozzle according to claim 1, characterized in that the outlet section of said duct is elliptic.

7. A nozzle according to claim 1, characterized in that the ejection duct is likely to receive an insert, internally fitted therein, and intended to reduce the inner diameter of the product passage.

8. A nozzle according to claim 1 characterized in that the ejection duct is constituted of a tubular element which is added and retained by means of a tight radial tightening in the exhaust hole of the swirl chamber.

9. A nozzle according to claim 2, characterized in that the axis of said duct is inclined according to an angle with respect to the axis of the swirl chamber.
